(19) United States
(12) Patent Application Publication
(10) Pub. No.: US 2011/0270528 A1
(43) Pub. Date: Nov. 3, 2011

(54) Method for Random Grouping of Multiple Parameters

(76) Inventors: Mariusz Lubomirski, Doylestown, PA (US); Jyotsna Kasturi, Bedminster, NJ (US)

(21) Appl. No.: 12/913,849

(22) Filed: Oct. 28, 2010

Related U.S. Application Data
(60) Provisional application No. 61/256,692, filed on Oct. 30, 2009.

(51) Int. Cl. G06F 19/00

(52) U.S. Cl. 702/19

(57) ABSTRACT

A method is provided for randomizing at least two factors among subjects, comprising (a) measuring said at least two factors in said subjects; (b) creating candidate solutions comprising said subjects; (c) evaluating fitness of said candidate solution; (d) forming a new generation from candidate solutions; and (d) repeating steps (c) and (d) to obtain a candidate solution with optimal fitness.

### CROSS REFERENCE TO RELATED APPLICATION

This application claims priority to application Ser. No. 61/256,692, filed Oct. 30, 2009.

### FIELD OF THE INVENTION

The present application provides a method for randomizing multiple covariate parameters for small study design.

### DESCRIPTION OF THE RELATED ART

For the pharmacology studies, any known prognostic factors should be equally represented across investigational groups to avoid bias and imbalance. Bias and imbalance among investigational groups are not desired as they may render the study invalid or lead to false conclusions. Another consideration for the pharmacology studies is the determination of the multiple covariate factors or parameters that may have a large influence on prognosis. For example, the study of metabolic disease treatment such as obesity and diabetes may consider covariate factors such as body weight, levels of glucose, insulin or triglycerides. The prognosis covariate factors are generally measured at baseline or prior to treatment then prioritized based on the target genes and their functions associated with the disease.

To ensure statistical similarity in the investigational groups and prioritization of covariate factors, group allocation methods including simple or complete randomization, block randomization, stratified randomization, and adaptive randomization may be carried out. Briefly, the simple or complete randomization method is based on a pure chance mechanism of distributing subjects to groups; the block randomization method ensures equal group sample sizes; the stratified randomization method focuses on balancing over the identified prognostic covariate factors; and the covariate adaptive randomization method assigns a subject to a particular group in a sequential manner based on the identified covariates and previous assignments using minimization techniques (Reviewed by Kao et al., J American College of Surgeons 206: 361-369, 2008 and Kang et al., J Athletic Training 43: 215-221, 2008).

These group allocation methods may be used alone or in combination depending on the conditions of the study. For example, block and stratify randomizations are often used together in practice (Kernan et al., J Clinical Epidemiology 52: 19-26, 1999). These methods have advantages and disadvantages. For example, simple randomization may results in group assignments with an unequal number of subjects, therefore causing an imbalance. This imbalance may be fixed by performing block randomization (Freedman and White, 1976). However, blocking randomization does not resolve the imbalance in prognostic factors. Additionally, stratified randomization requires selection of relevant stratification variables which may be difficult and may not be useful when there are no homogeneous subgroups. These problems are especially critical for studies with small sample sizes. Therefore, when not performed properly, randomization may cause the groups to be biased and render the experiment invalid and inefficient (Kernan et al. 1999; Hewitt and Torgerson 2006; Grizzle 1982).

In clinical studies, large sample sizes and complete randomization are used to reduce imbalance and to allocate treatments to subjects based on a chance mechanism such that the treatment to be given cannot be predicted. This creates comparable groups with no systematic differences; therefore, the treatment effect is the only dissimilarity to be measured among the investigational groups. Such approach is not applicable to study where the sample or subject sizes are small, such as the preclinical or nonclinical studies. The imbalance risk of small studies may be removed, in theory, by introducing covariate analysis with statistical methods such as ANCOVA methods. However, this post-study approach makes the interpretation of results difficult from covariate imbalance and may result in unexpected interaction effects such as unequal slopes among subgroups of covariates (Kang et al. 2008; Frane 1998; Lomax 2001).

Because of the limited study subjects and the unclear model for small studies, manual processing is commonly used to balance covariate factors across treatment groups for the study design. This increases the risk of operator bias and the departure from the randomization principle. Also, the current manual processing is time consuming and labor intensive. Further, the study design generated by manual process may be inconsistent and may render study invalid.

Therefore, there is a need of a method to systemically and efficiently reduce baseline imbalance for small studies. The objective of the present application is to provide a method based on genetic optimization to randomize multiple covariate factors and develop statistically balanced design for small studies.

### SUMMARY OF THE INVENTION

One objective of the present application provides a method for randomizing at least two factors among subjects, comprising the steps of (a) measuring said at least two factors in said subjects; (b) creating candidate solutions comprising said subjects; (c) evaluating fitness of said candidate solution; (d) forming a new generation from candidate solutions; and (e) repeating steps (c) and (d) to obtain a candidate solution with optimal fitness.

Another objective of the present application provides a method for randomizing at least two factors among subjects, comprising the steps of (a) measuring said at least two factors in said subjects; (b) assigning a binary representation to said subject; (c) creating candidate solutions comprising said subjects; (d) evaluating cost function of at least two factors for said candidate solution; (e) forming a new generation from candidate solutions having low values of cost function; and (f) repeating steps (d) and (e) to obtain a candidate solution with minimal value of cost function.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1. A schematic view of the binary representation.

FIG. 2. A schematic view of the genetic algorithm for randomization.

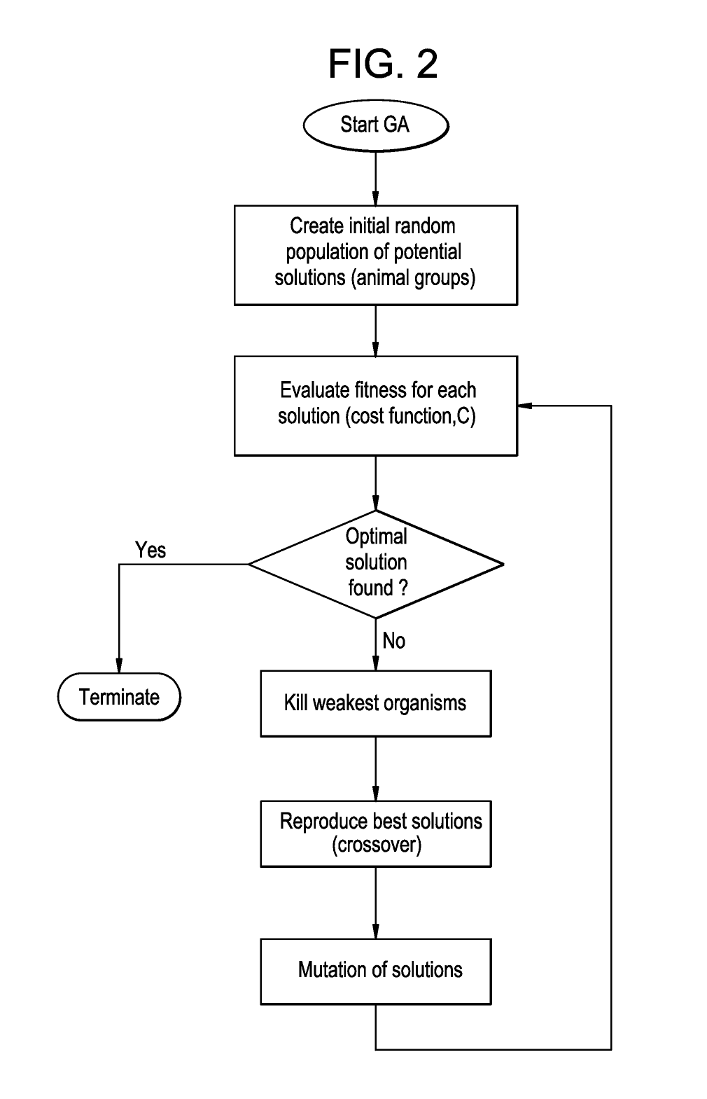

FIG. 3. The value of the cost function C at each iterative step of the randomization.

FIG. 4. The imbalance in group allocation generated by complete randomization.

FIG. 5. The baseline randomization for a study conducted with the present method. A total of about 64 rats and about 6 different parameters of insulin, percent fat, body weight, plasma triglyceride, glucose and free fatty acid are divided into about 8 treatment groups of about 8 rats per treatment group.

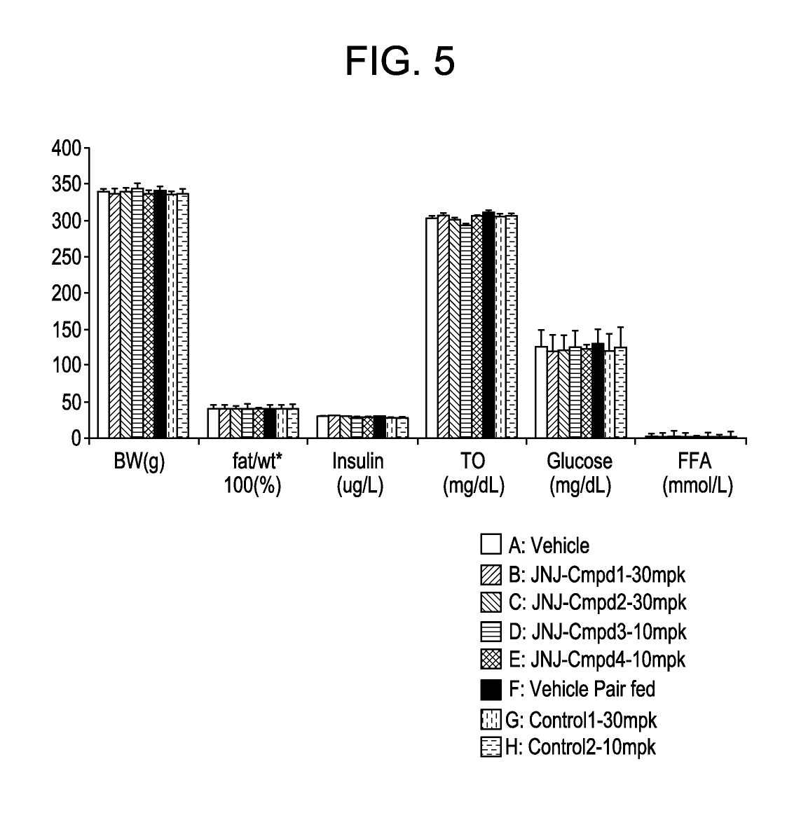

FIG. 6. The levels of plasma insulin in the rats treated with oral dosing of vehicle, Compounds 1, 2 and 3 for about 11 days.

### DETAILED DESCRIPTION OF THE PRESENTLY PREFERRED EMBODIMENTS

One aspect of the present application provides a method for randomizing at least two parameters among subjects. The method comprises measuring at least two factors in subjects, generating candidate solutions, evaluating fitness of each candidate solution, forming a new generation of candidate solutions and obtaining the candidate solution with optimal fitness.

According to the present application, the method may be used for balancing covariate factors or group allocations when sample or subject sizes are small such as pre-clinical or non-clinical trials. The method may be used in any therapeutic area such as cancer (tumor size, biomarkers), cardiovascular (infarct size, circulating lipids) etc and may be performed by investigators in industry or for scientific research to investigate a particular process, system or drug. As used herein, the term ‘sample’ or ‘subject’ refers to animals, such as bovine, canine, cavia porcellus, chicken, cobra, donkey, eel, equine, feline, frog (x. laevis, r. catesbeiana, r. shgiperica), gerbil, goat, hamster, lamprey, lungfish, primates (macaque gorilla, chimpanzee, orangutan, rhesus monkey), mouse, pig, rabbit, rat, bird, salamander, salmon (alb1 & alb2), sheep, turkey, fish, zebrafish and the like.

By way of example, the method is used for animal studies of metabolic disease treatments. Since different genes or targets are associated with each metabolic disease, the covariate factors may differ depending on the objective or the treatment of the studies. The covariate factors may be selected from the list of variables or factors upon which stratification occurred. The covariate factor or parameter may be any feature of the subject, such as biological feature, physiological feature, phenotypical feature, or a biological or physiological response after a treatment. As used herein, the terms ‘factor’, ‘parameter’, ‘variable’, ‘covariate factor’, ‘baseline factor, ‘baseline covariate factor’ or variation thereof may be used interchangeable.

By way of example, the covariate factors may be physiological parameters. As shown in Table 1 below, studies of treating metabolic disease such as obesity and diabetes may include factors such as plasma triglycerides, free fatty acids, glucose and insulin, measurements of body composition, such as weight and percent fat.

TABLE 1
Covariate factors to be considered for metabolic disease study.

| | 1st | 2nd | 3rd | 4th |
|---|---|---|---|---|
| Target Function | priority | priority | priority | priority |
| Insulin Resistance | Insulin | Triglyc- | Body Weight | Glucose |
| | | erides | | |
| Obesity/Diabetes | % fat | Insulin | Glucose | Body Weight |
| Obesity Only | % fat | Body Weight | Insulin | |
| Lipid de novo | Triglyc- | Insulin | % fat | FFA |
| | erides | | | |
| Diabetes Only | Glucose | Insulin | | |
| Unknown | Glucose | Insulin | % fat | Body Weight |

It is found herein that genetic algorithm may be modified for the objective of the present application. Genetic algorithm (GA) is based on biological evolution where generations of species are created and some offspring of the new generation are superior compared to the previous generation (Holland 1975). Therefore, the present method comprises steps for measuring the fitness and for forming a new generation, which are repeated until no further reduction in the value of the penalty or cost function can be achieved. The candidate solution with the minimum or lowest value of the cost function may be the optimal candidate solution.

By way of example, the present method provides treatment groups in an animal study which has an input data X containing k observed baseline covariate factors for N animals. A candidate solution is generated to randomly divide the N animals into m treatment groups wherein each treatment group consisted of p animal (N=p×m). About 1,000 candidate solutions are generated and evaluated for means and variations for each covariate factor. Then mean and variation of multiple covariate factors are minimized as a cost function C. About 100 candidate solutions have the about 100 lowest values of cost function C are selected to form a new generation of about 900 candidate solution. The about 100 candidate solutions and the about 900 candidate solutions are evaluated for cost function C. The process is repeated for about 100 generations or iterations to obtain the candidate solution with the minimal value of cost function C for the animal study design.

It is also found herein that a binary representation of a study subject improves the process as the evaluation of the fitness of each candidate solution and the formation of the new generation may be conducted numerically and reduce the processing time. For example, the binary representation for 2 animals in a study would be (1 0) and (0 1). The binary representation for 3 animals in a study would be (1 0 0), (0 1 0), (0 0 1) and (0 0 1). Similarly, the binary representation for 4 animals in a study would be (1 0 0 0), (0 1 0 0), (0 0 1 0) and (0 0 0 1). Accordingly, a person skilled in the art would be able to assign the binary representation for N animals in a study as (1 0 00 . . . N), (0 1 0 0 . . . N), (0 0 1 0 . . . N), (0 0 0 1 . . . N), (0 0 0 0 . . . 1 0 N) . . . and (0 0 0 . . . 0 1 N).

After assigning the binary representation to the study subject or animal, the process for baseline randomization and group allocations may be initiated by creating a population of candidate solutions comprising treatment groups. The objective of the process is to find a candidate solution or a set of candidate solutions with optimal fitness or minimal variation among treatment groups. Any number of candidate solutions may be randomly generated; for example about 200 to about 3,000 candidate solution. Preferably, about 300 to about 2,000 candidate solutions are generated. A person skilled in the art may determine the number of candidate solutions based on his or her experience, the study condition, the system requirement, or the processing time. By way of example, about 1,000 candidate solutions are generated for one animal study.

Each candidate solutions may comprise a number of treatment groups and each treatment group may comprise a number of study subjects. The candidate solution may comprise at least two treatment groups, preferably about 3 to about 10 treatment groups and more preferably about 4 to about 8 treatment groups. The treatment group may comprise at least two subjects, preferably about 4 to about 50 subjects and more preferably about 5 to about 10 subjects. Additionally, candidate solutions may have equal or unequal numbers of treatment groups. By way of example, about 1,000 candidate solutions having equal numbers of treatment groups are generated.

The treatment group may obtain a unique binary representation based on the binary representations of the study subjects. For example, when two animals with the binary representations of (1 0 0 0) and (0 0 1 0) are in the same treatment group, the binary representation of the treatment group would be (1 0 1 0).

Mean and variation for each baseline covariate factor across the treatment groups of each candidate solution may be determined. Then mean and variation of multiple covariate factors of each candidate solution may be combined and represented as a single value of cost function C. Therefore, cost function C may be used to evaluate whether multiple covariate factors are balanced in a given candidate solution or represent the fitness of a candidate solution. The objective is to find minimal variation in multiple parameters across treatment groups. Therefore, a candidate solution with lowest cost function C (i.e. optimal fitness) is desired.

The cost function C may be determined using the Euclidean distance of Eq. 1 described below.

$$Objective ( cost ) function , C = {{L}_{2}}_{param} 〈 {w}_{p} \sqrt{{\sum }_{i = 1}^{gps} \frac{{μ}_{i}^{2}}{{σ}_{i}^{2}}} , 0 〉 \qquad Eq . 1$$

wherein L is Eucleadian norm, gps is number of groups, wₚ is weight factor, μ is mean and σ is variation of the mean. Briefly, a set of optimized n-parameters formed n-tuples of real numbers (x₁, x₂ . . . xₙ) wherein each xᵢ representing a sum of the inverse coefficients of variations across the groups for a given covariates. The dot product between the n-tuple and Euclidean orthonormal basis allows for calculation of the resultant vector which measures the distance from the origin. The variable wₚ incorporated two aspects of a weighting scheme: (1) to normalize the data to make the covariates comparable in both magnitude and scale, and (2) to allow a user-specified value that determines the importance given to each covariate during randomization and constraint optimization.

A subset of candidate solutions with cost function lower than other candidate solutions may be considered as providing better fitness or balance of baseline covariates and selected to be used as parent to generate a new generation. The next generation of candidate solutions may be formed by crossover and mutation, either independently or combined in any sequence such as crossover followed by mutation or mutation followed by crossover. About 20 to about 250, preferably about 50 to 150, candidate solutions may be selected to form the new generation. By way of example, about 100 candidate solutions are selected and used to form the offspring.

As used herein, the term ‘crossover’ refers to creating a random partition within two candidate solutions then swapping the random partitions between the two candidate solutions; and the term ‘mutation’ refers to randomly assigning a binary representation within a candidate solution. For example, the new generations may be created using mutations alone by randomly exchanging two subjects between two treatment groups.

The candidate solutions of the next generation and the subset of candidate solutions may be combined and evaluated for cost function as described above. The steps of fitness evaluation and the new generation may be repeated numerous times to obtain a candidate solution with optimal fitness. The process may be repeated in a large number to provide statistical balance. The process may be repeated from about 100 to about 2,000 times, preferably from about 200 to 1,500 times, and more preferably from about 300 to about 1,000 times.

In one embodiment, the method comprises the steps of (a) generating an initial of about 1,000 candidate solutions, (b) evaluating fitness of each candidate solution, (c) selecting a subset of about 100 candidate solutions and removing the subset of remaining about 900 candidate solutions, (d) forming a new generation of about 900 candidate solutions using the subset of about 100 candidate solutions; (e) repeating steps (b) and (c) for about 100 times to obtain the candidate solution with optimal fitness.

In another embodiment, the method comprises the steps of (a) measuring at least two factors in study subjects, (b) generating an initial of about 1,000 candidate solutions comprising study subjects, (c) evaluating cost function of at least two factors in each candidate solution, (d) selecting a subset of about 100 candidate solutions having about 100 lowest values of cost function and removing the subset of remaining about 900 candidate solutions, (e) forming a new generation of about 900 candidate solutions using the subset of about 100 candidate solutions; (f) repeating steps (c) and (d) for about 100 times to obtain the candidate solution with the minimal value of cost function of at least two factors.

According to the present application, all study or experimental subjects are analyzed using genetic algorithm to ensure multiple covariate parameters are randomized. By way of example, the present method is used for in-vivo pharmacology where there are a large number of combinatorial factors such as multiple local optima, randomizing subjects into groups, creating groups with near equal means and variances across physiological parameters of interest.

The optimization techniques may minimize or maximize an objective function by systematically choosing values of variables from within a permissible set of values, and repeat the process to find the best solution. A genetic algorithm (GA) is a type of the optimization technique inspired by biological evolution where generations of species are created and some offspring of the new generation is superior compared to the previous generation (Holland 1975). When applied to numerical problems, the GA procedure typically works by first generating a population as an initial set of possible candidate solutions then candidate solutions are selected based on their fitness by measuring against objective functions determined based on the problem. Thus, by providing means for measuring the fitness of each new offspring and creating new generation from crossover and mutations, the best solution or set of solutions may be obtained.

GA may be used when traditional gradient search optimization techniques fail; for example, when there are discontinuities in gradients, unreliable derivatives, heavy non-linearities, combinatorial possibilities and multiple local optima. GA has been applied in physiologically based pharmacokinetic modeling (Bies et al. 2006) decision support for cancer chemotherapy (McCall and Petrovski 1999) and finding shape of protein molecules (Unger 2004).

Another aspect of the present application provides a system such as a computer apparatus or computer-based system adapted to perform any one of the methods described herein. By way of example, to quantify the individual contribution of a covariate factor or combination of covariate factors to a drug treatment. The computer apparatus may comprise a processor means incorporating a memory means adapted for storing data; means for inputting data relating to the animal study and drug treatment; and computer software means stored in said computer memory that is adapted to perform a method according to any one of the embodiments of the present application described herein and output group allocations and study design with reduced bias from the covariate factors.

A computer system of this aspect of the present application may comprise a central processing unit; an input device for inputting requests; an output device; a memory; and at least one bus connecting the central processing unit, the memory, the input device and the output device. The memory should store a module that is configured so that upon receiving a request to quantify the input data all subjects, to balance contribution of covariate parameters, it performs the steps listed in any one of the methods of the present application described herein.

In the apparatus and systems of these embodiments of the invention, data may be input by downloading the input data from a local site such as a memory or disk drive, or alternatively from a remote site accessed over a network such as the internet. The input data may be input by keyboard, if required.

The generated results may be output in any convenient format, for example, to a printer, a word processing program, a graphics viewing program or to a screen display device. Other convenient formats will be apparent to the skilled reader.

The means adapted to quantify the input data from all subjects, or to balance contribution of covariate parameters will preferably comprise computer software means. As the skilled reader will appreciate, once the novel and inventive teaching of the invention is appreciated, any number of different computer software means may be designed to implement this teaching.

Another aspect of the invention provides a computer program product for use in conjunction with a computer, said computer program comprising a computer readable storage medium and a computer program mechanism embedded therein, the computer program mechanism comprising a module that is configured so that upon receiving a request to quantify the input data from all subjects, or to balance contribution of covariate parameters, it performs the steps listed in any one of the methods according to the present application.

A further aspect of the present application is related to systems, computer program products, business methods, server side and client side systems and methods for generating, providing, and transmitting the results of the methods described herein.

The invention is not limited by the embodiments described above which are presented as examples only but can be modified in various ways within the scope of protection defined by the appended patent claims.

### Example 1

### Methodology

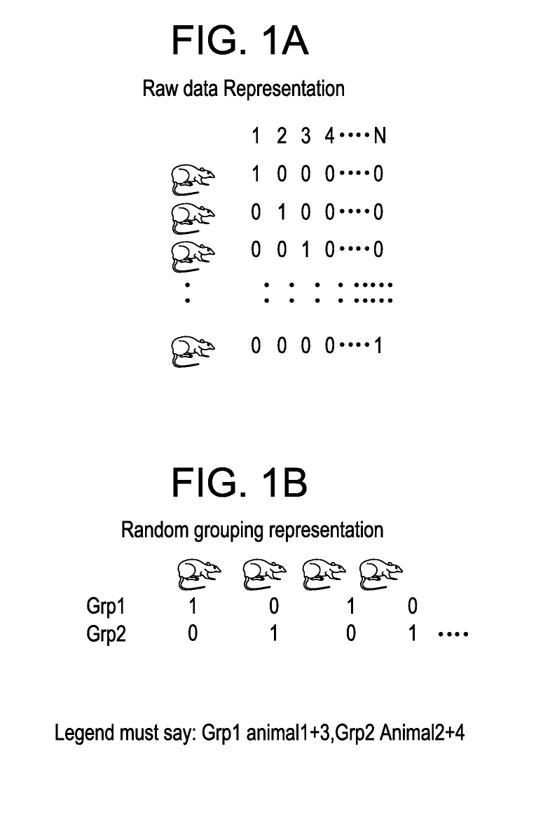

The input data X containing k observed baseline covariates for N subjects or animals was analyzed to create a random grouping of m treatment groups and each treatment group consisted of p animal (N=p×m). The covariate factors were selected from the list of variables upon which stratification occurred. Each animal was assigned a unique binary representation and an identity matrix of each row representing a separate animal was provided (FIG. 1).

Genetic algorithms were modified to randomize multiple covariate parameters with variable magnitudes and scales and further prioritize the covariate parameters according to the treatment. The baseline randomization or balance was generated by actively optimizing the group averages and variance across each of the selected covariates. The complete approach includes the following four parts:

(1) Generating an initial generation for candidate solutions

(2) Evaluating fitness of each candidate solution

(3) Forming a new generation from candidate solutions

(4) Obtaining the candidate solution with optimal fitness

### Part 1: Creating Candidate Solutions

The randomization process was initiated by creating a population of randomly generated candidate solutions. Each candidate solution comprised a number of treatment groups which would be part of any ongoing experiment. Each candidate solution was evaluated against a cost function to examine which candidate solution provided the best balancing of covariate factors at baseline or prior to the study. About 1,000 candidate solutions were generated. Each treatment group inherited a unique binary representation from the binary representations of the animals as described above.

### Part 2: Evaluate Fitness of Each Candidate Solution

To minimize the inverse coefficient of variation for the candidate solutions, multiple covariate parameters were combined through the Euclidean distance of Eq. 1 described below.

$$Objective ( cost ) function , C = {{L}_{2}}_{param} 〈 {w}_{p} \sqrt{{\sum }_{i = 1}^{gps} \frac{{μ}_{i}^{2}}{{σ}_{i}^{2}}} , 0 〉 \qquad Eq . 1$$

wherein L is Eucleadian Norm, gps is number of groups, Wp is weight factor, μ is mean and σ is the variation of the mean.

Each candidate solution was evaluated against a cost function C for their fitness. Briefly, a set of optimized n-parameters formed n-tuples of real numbers (x₁, x₂ . . . xₙ), wherein each xᵢ representing a sum of the inverse coefficients of variations across the groups for a given covariates. The dot product between the n-tuple and Euclidean orthonormal basis allowed calculation of the resultant vector which measured the distance from the origin. The objective was to find a vector with the smallest norm value. The variable wₚ incorporated two aspects of a weighting scheme: (1) to normalize the data to make the covariates comparable in both magnitude and scale, and (2) to allow a user-specified value that determines the importance given to each covariate during randomization and constraint optimization.

Part 3: Forming a New Generation from the Candidate Solution

A subset of about 100 candidate solutions that had the lowest 100 values of the cost function C which has the optimal fitness among the initial about 1,000 candidate solutions was selected. The remaining about 900 candidate solutions were discarded. The retained about 100 solutions formed a new generation that were used to reproduce by crossover and mutation to generate another generation of about 900 children. A crossover between two candidate solutions was performed by creating a random partition of the groups then swapping them between solutions. The mutations were performed on those animals that may have been assigned to more than one group with a toggle of a binary bit representation on all but one of the groups at random.

Part 4: Obtaining a Candidate Solution with Optimal Fitness

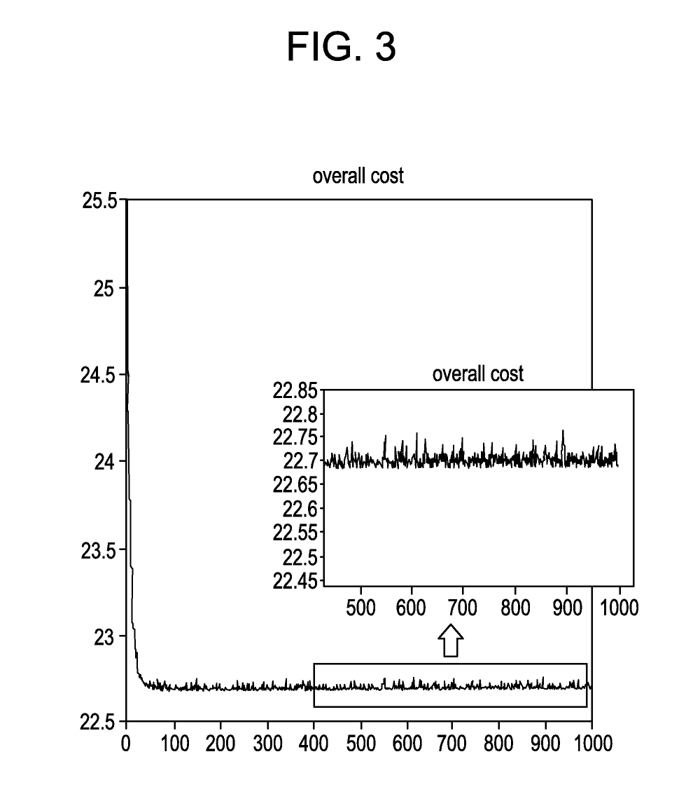

The about 100 parent candidate solutions and the about 900 new generations were evaluated for their cost function as described in part 2. Then about 100 candidate solutions with the lowest values of cost function were selected as parent to form a second new generation. This was continued repeatedly for about 1,000 times. FIG. 3 illustrated the value of cost function C at each iterative step. As shown in FIG. 3, the optimal value was reached in less than about 100 generations or iterations of parts 2 and 3.

### Example 2

### Single Factor

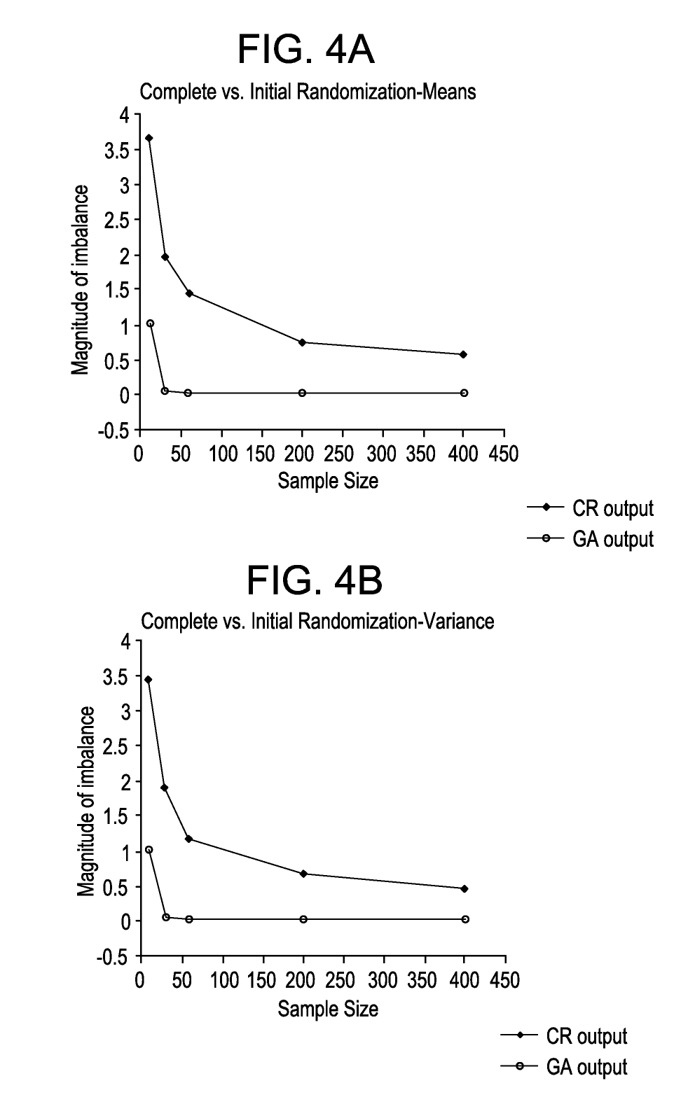

A metabolic study of insulin resistance with one covariate of insulin levels was designed and evaluated. Two treatment groups were generated using the method described in Example 1 and the complete randomization method. Both methods were implemented in Matlab. FIG. 4 showed the output of two treatment groups with varying subject sizes. The x-axis indicated the groupings of various subject sizes of less than about 400 and the y-axis indicated the relative differences among the generated groups in means and variances.

The results in FIG. 4 showed that the output of the complete randomization generated an imbalance by a factor of about 3.5 in both group means and variance compared to those of the present method. Also, the results showed that even when the sample size was small, the method of the present application produced low imbalance. The results further showed that when the sample size increased, the means became equal for present method. However, when the sample sizes increased to about 400, simple randomization still showed certain extent of bias or imbalance.

### Example 3

### Multiple Factors

An animal study of about 64 Zucker fa/fa rats and about 6 different parameters were analyzed. The animals were grouped into about 8 equal groups of about 8 rats per group using the method described in Example 1. The covariate factors were prioritized and weighted in the order of plasma insulin, percent body fat, body weight, plasma triglycerides, glucose, followed by free fatty acid (FFA). The tight groups were observed in the boxplot (data not shown).

Using the method described in Example 1, the randomization and group allocation were completed in less than about 5 minutes. This time period was shorter compared to those the manual process which generally took more than 2 hours.

The treatment groups were then subjected to about 8 different treatments including D.I. water, Compounds 1, 2, 3, and 4, each at about 30 milligrams per kilogram body weight (mpk), control at about 30 mpk and at about 10 mpk. The animals were treated for about 11 days.

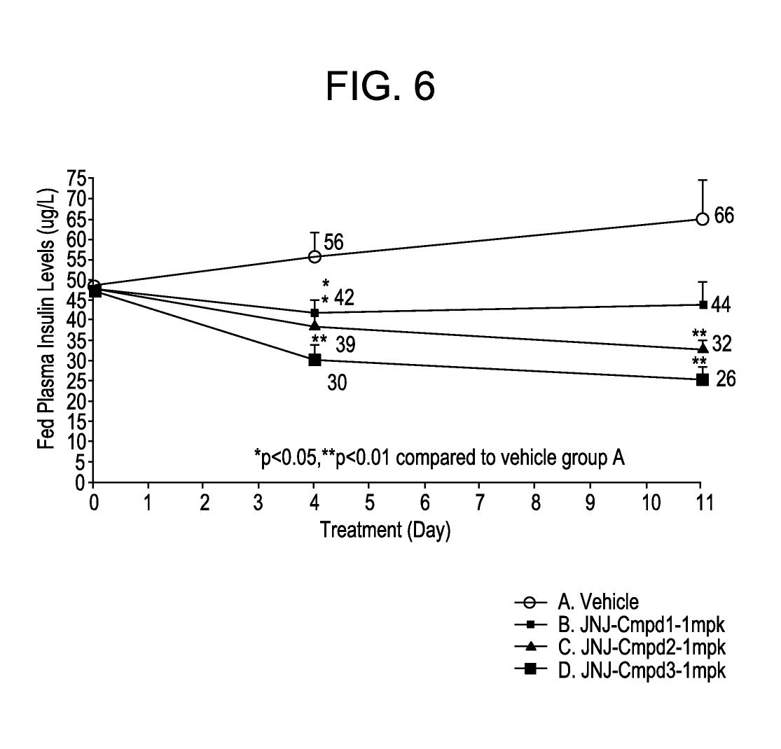

As shown in FIG. 6, Compounds 1, 2 and 3 had different effects in animals. When compared the plasma insulin levels over time, the glucose level in the group treated with Compound 3 was lower than those of Compound 2 and those of Compound 1. As Compounds 1, 2, and 3 had similar chemical structures, the difference in modulating glucose levels may not be observed if the study did not use the tightly randomized groups as provided herein.

Further, about 5 additional parameters were measured in the same study (data not shown), thereby maximizing the outcome of one study.

We have presented a novel application of genetic algorithms to the stratified randomization problem in preclinical trials where small sample sizes are predominant and the risk of imbalance is high. The algorithm shows excellent performance as demonstrated. The method is capable of seamlessly randomizing over multiple covariate parameters with variable magnitudes and scales and allow a prioritization of important covariates.

We claim:

1. A method for randomizing at least two factors among subjects, comprising:
(a) measuring said at least two factors in said subjects;
(b) creating candidate solutions comprising said subjects;
(c) evaluating fitness of said candidate solution;
(d) forming a new generation from candidate solutions; and
(e) repeating steps (c) and (d) to obtain a candidate solution with optimal fitness.

2. The method of claim 1, wherein said fitness in step (c) is determined by a cost function.

3. The method of claim 1, wherein said new generation in step (d) is formed by crossover.

4. The method of claim 1, wherein said new generation in step (d) is formed by mutation.

5. The method of claim 1, wherein said new generation in step (d) is formed by crossover and mutation.

6. The method of claim 1, further comprising assigning a binary representation to said subject.

7. The method of claim 1, wherein said subject is an animal.

8. The method for randomizing at least two factors among subjects, comprising
(a) measuring said at least two factors in said subjects;
(b) assigning a binary representation to said subject;
(c) creating candidate solutions comprising said subjects;
(d) evaluating cost function of at least two factors for said candidate solution;
(e) forming a new generation from candidate solutions having low values of cost function; and
(f) repeating steps (c) and (d) to obtain a candidate solution with minimal value of cost function.
